(19) United States
(12) Patent Application Publication
(10) Pub. No.: US 2025/0187959 A1
(43) Pub. Date: Jun. 12, 2025

(54) LAGOON BASED ANAEROBIC SBR/UAC REACTOR SYSTEM WITH MULTIPLE CELLS

(71) Applicant: SUSTAIN TECHNOLOGIES, LLC, Charlotte, NC (US)

(72) Inventors: Robert Hickey, Okemos, MI (US); James M. Wallace, Charlotte, NC (US)

(21) Appl. No.: 18/533,129

(22) Filed: Dec. 7, 2023

(51) Int. Cl. C02F 3/28

(52) U.S. Cl. CPC C02F 3/2866; C02F 3/2846

(57) ABSTRACT

A process for anaerobically treating a feed of manure that contains liquid and suspended solid in a reaction that uses a multicell lagoon reactor (MCLR) wherein the reaction system has an input cell, an output cell, and one or more intermediate cell all in series and located at least partially below the ground. A partition separates the cells to restrict a gravity induced flow of liquid and solids retained cell. The solids retention time exceeds the hydraulic retention time in each cell. Enclosing the cells enables collecting of biogas from the cells. At least an input cell operates as an anaerobic sequencing batch reactor that undergoes periodic mixing. An output cell provides treated liquid for recovery.

### FIELD OF INVENTION

The present subject matter relates to methods and processes for treating manure streams from animal husbandry and livestock operations. In further detail this invention relates to a method for the treatment of solids and the recovery of water from manure produced in dairy and swine operations and more particularly, methods and processes for managing untreated or partially treated dairy or swine manure that enters one or more treatment/storage lagoons for the treatment of solids and the recovery of water.

### BACKGROUND OF THE INVENTION

Ruminant animal farming operations and swine production generate raw manure often referred to as flush manure (FM). The content of the manure varies based on the type of operations generating the manure. The total suspended solids in swine manure (SM) contains, because of their diet, very little high fibrous material. Whereas manure from ruminant animal operations contains a significant quantity of high fibrous material. Removal of the coarse fibrous material produces coarse screened manure (CSM) that is essentially free of large fibrous material and that constitutes liquid and solids. Typical treatment of the SM and CSM breaks down suspended solids contained therein and produces a liquid with a reduced volume of solids and usually includes the separation of solids from the liquid. Advanced CSM and SM treatment methods use a wide variety of equipment and equipment arrangements to carry out these basic steps. In addition to basic steps, most CSM and CS treatment methods involve additional steps and ancillary equipment to tailor the method to specific characteristics of the recovered CSM or SM and the desired outputs. The resulting CSM and SM from dairy and hog operations require management that includes treatment of solids and recovery of water.

In more detail the FM is recovered mainly from dairy and swine operations. by the flushing of animal stalls, housing, and areas of confinement. The amount of high fiber in the FM varies with the animal in confinement and typically includes undigested and/or partially digested animal feed. Again swine FM typically lacks high fiber material. FM from dairy operation for example will contain high fiber material such as straw, sawdust, or other bedding that becomes mixed with their excrement. The recovery of the dairy CSM requires the removal primarily of the larger coarse fibers because of the lignin and lignin-carbohydrate complexes present in these complexes that resist breakdown within the time frame of typical anaerobic digestion systems. Moreover, the recovered fiber is amenable to use a fuel product, animal bedding, and construction materials.

Most CSM and SM enter a storage location in the form of a lagoon or pond. Lagoons are typically formed as excavated earthen pits, earthen embankments, or a combination of the two. Storage operation may use a single lagoon or multiple lagoons. A typical operation for SM uses a single lagoon. Lagoons for other animal operations that produce CSM typically use multiple lagoons of an unmixed type. Earthen lagoons for CSM also retain water from milking parlors, etc. and in either case the earthen lagoons promote settling and decomposition of organic matter entering such lagoons. The lagoons also provide some degradation of the dissolved organics such that the effluent can be used for flushing and the water has sufficient suspended solids holding capacity.

Overall lagoons differ from manure storage ponds in typically providing some form of solids treatment; having a much larger size than a storage pond; and storage ponds are typically emptied at the end of a storage period. A manure containment structure which is not emptied at the end of the storage period normally operates as a lagoon. This invention applies to lagoons versus storage ponds.

In most cases only wastewater with a solids content of about 5% and typically less regularly exits the lagoon if there is no agitation. Accordingly, solids accumulate in a lagoon until they are removed and land applied. Because of long storage periods lagoons often become overloaded with CSM/SM and emit offensive odors. In a typical cycle for SM, lagoon emptying occurs about once every ten or more years or as necessary to restore a desired treatment volume. Because of the mass of solids in CSM/SM that enters some lagoons, particularly from dairy, management of the lagoon(s) may partially empty a lagoon up to several times per year to extract solids from the bottom of lagoons by means such as a drag line.

It is known to add anaerobic digestion (AD) to the handling and processing of FM. Addition of AD can improve environmental stewardship, reduce odors, lower fugitive emissions, and provide biogas for sale or use on site, especially in the generation of electricity. In fact, much recent attention looks to the methane gas produced by AD in manure processing operations to provide biogas for conversion to renewable natural gas (NRG).

In particular, wastewater treatment by an anaerobic sequencing batch reactor (AnSBR) is known. U.S. Pat. No. 5,185,079 describes its basic design and operation and is herein incorporated by reference.

Economic challenges of processing the FM limit the use of different forms of anaerobic digestion (AD). Employing AD, especially for SM, requires substantial modifications in CSM/SM storage and its processing. Thus, many growers consider these benefits to not outweigh the required investment and operation costs to employ AD.

AD provides the highest relative reduction in fugitive methane emissions. AD systems emit less methane compared to uncovered anaerobic lagoons because the methane that is produced in AD is captured and destroyed or utilized.

Another complication/cost arises from the need to adapt the treatment systems to variations in the recovered waste. In the case of ruminant animals, the waste includes not only feces and urine but also bedding materials, feed matter, water from drinking or washing, and other matter or liquid associated with the raising of such animals.

In the production of swine, the quantity of generated SM varies during the different life phases of growing hogs and pigs; piglets will produce minor amounts of manure whereas the average feeder pig of 270 pounds or less will produce about ten pounds of manure per day and large pigs, 400 to 500 pounds will produce around 20 pounds of manure per day.

U.S. Pat. No. 10,781,143 treats organic waste containing fibrous material by recovering coarse fibers that pass to a biogas digester and mechanically separates the effluent from the biogas digester into a concentrated fraction and a liquid fraction. The liquid fraction after heating to a temperature below the liquid's boiling point enters a flash column to partially remove volatile carbon dioxide. The heated flash liquid passes to an ammonia removal unit that removes ammonia from the liquid. The ammonia free liquid passes through a reverse osmosis unit for the recovery of an ammonia free liquid and a potassium rich fraction useful as a fertilizer concentrate.

A wide variety of equipment in a plurality of configurations have been used to recover valuable products from animal waste. A liquid stream of CSM/SM comprises primarily water and suspended solids that include biological material in the form of volatile dissolved and suspended solids. Removal and conversion of the suspended solids, and the soluble organic compounds, purifies the water and concentrates the remaining solids. Purification removes most of the remaining solids from the liquid to provide recycle water.

Most desirably anaerobic digestion (AD) provides the essential breakdown of soluble organics and suspended solids contained in CSM/SM with high COD removal efficiencies and low sludge production. In addition to AD, methods and systems integrate one or more of biological treatment, separation, stripping, scrubbing, settling, and contacting into a complete process for treating manure. Dahlan et al, (J Adv Sci Res, 2013, 4(1): 07-12 Journal of Advanced Scientific Research, 2013) describe the use of AD that retains a flocculent bed and can operate with high or low rates to treat high levels of organic and suspended solids in waste streams. U.S. Pat. No. 5,184,079A shows an anaerobic batch reactor with settlement of the biomass under quiescent conditions.

The SCM/SM from swine and ruminant animals contains high amounts of organic nitrogen. Recovered nitrogen can have high value in the production of fertilizers and other nitrogenous compounds such as ammonium carbonate and ammonium bicarbonate. The isolated solids residues from the processing of the SCM/SM can also provide nutrient rich fertilizers, soil adjuvants, and soil amendments. U.S. Pat. Nos. 8,486,359, 8,580,219, 10,793,458, 10,604,432, and 10,106,447, show recovery of ammonium carbonate (AC) and ammonium bicarbonate (AB) by anaerobically digesting agricultural, municipal and/or industrial wastewater and concentrating gaseous ammonia to produce AB and AC from wastewater containing ammonia using gas separation, condensation, and filtration, at controlled operating temperatures.

Thus, given the multiplicity of benefits of advanced manure treatment a need exists to make advanced treatment such as AD less expensive, more efficient, and more flexible. Reducing the cost and facilitating the utilization of advanced AD treatment will encourage its use to provide environmental benefits and grower profitability in the conversion and repurposing of the waste products in animal production and operations.

### SUMMARY OF THE INVENTION

This invention makes the processing of SCM/SM more profitable by reducing capital expenditure with a process adaptable to variations in SCM/SM that uses a relatively small lagoon that contains a plurality of cells arranged for serial flow of SCM/SM through a multi-cell lagoon reactor (MCLR)). The solids retention time (SRT) in the MCLR significantly exceeds the hydraulic retention time (HRT) in each cell and one or more cells provide anaerobic digestion. This invention reduces the volume requirements of a treatment lagoon while also providing a novel arrangement with a unique cell arrangement that reduces the overall cost and increases the treatment capability of lagoons for retention and treatment at reduced capital and operating cost. In all cases the design is based on having cells in series inside a lagoon type structure to treat wastewaters with a significant concentration of suspended solids.

In the process liquid flows through the cells of the MCLR by gravity such passing liquid through each successive cell to eliminate any necessity of pumping liquid from one cell to another. Because of this unique design it is possible to form the MCLR in an earthen lagoon or a tank/vault using concrete or other materials. This type of construction further reduces the overall cost of the MCLR process.

Livestock, dairy operations, and swine production benefit from this novel process and lagoon arrangement in the reduction of solids and production of usable water streams. Such uses include irrigation; maintaining other retention lagoons in substantially cleaner conditions; and, with additional treatments, use in animal cooling and animal drinking water. The cleansed water can also improve the flushing of the sand lanes and scraped manure removal using water flumes or alley flushes.

At least one cell in the MCLR process will operate as an anaerobic sequencing batch (AnSBR) type zone and at one cell with operate as an up flow anaerobic contact (UAC) zone so that the overall operation of MCLR process cells may operate as a hybrid of both an AnSBR and a UAC. Thus, unlike conventional processes that require an external unit operation (settling or flotation) to capture and return solids to obtain a high removal efficiency for COD, the solids retention achieved by providing an AnSBR and/or UAC in one or more cell in series with other cells achieves a desired level of treatment without external recycle of solids. In some cases, recycling of settled solids within a cell of the MCLR process arrangement back to an upstream cell in the series, such a cell operating as a UAC cell, may be employed to further increase the overall SRT.

In all cases the SRT of the cells exceeds, and often significantly exceeds the HRT thereby enabling the accomplishment of a high degree of treatment in a much shorter overall HRT. The HRT of the cells typically, and more often greatly, exceeds that achievable in a continuous stirred tank reactor design (CSTR) type process design. The final cell in the MCLR usually functions as a settling cell. Operating the process with a final settling cell can produce a better overall quality effluent.

The MCLR provides a unique operational flexibility where a single cell can vary its operation from an AnSBR, a UAC, a retention cell, or a settling cell. This feature provides substantial benefits where the quantity or composition of solids may vary with changes in the environment of the animals, seasonal water use (such as cow cooling) or, especially in the case of swine production, their growth phase.

Accordingly in one aspect the invention treats a feed of swine and/or dairy manure that comprises liquid containing suspended solids. The process uses anaerobic digestion in a reaction system wherein the reaction system has an input cell, an output cell, and at least one intermediate cell all in series and located at least partially below the adjacent ground level in a lagoon. Each cell retains a volume of liquid and suspended solids. A partition restricts the flow of liquid and suspended solids between cells. Each cell operates with an SRT that exceeds its HRT. One or more enclosures cover the cells to collect biogas from the cells. The feed periodically passes to the input cell to produce a periodic gravity induced flow of liquid comprising a supernatant and entrained solids from the input cell serially through any intermediate cells and from the final intermediate cell into the output cell. The process minimizes mixing in the cells to settle out solids directly before feeding new manure and thereby increase the passing of supernatant and decrease the passing of solids to a downstream cell in the supernatant. The input cell and/or one or more intermediate cells operate as an anaerobic sequencing batch reactor (AnSBR). Solids and liquid receive periodic mixing in the AnSBR for at least a portion of the time between the periodic additions of feed. Treated solids are recovered from below the midpoint of the output cell and treated liquid from above the midpoint of the output cell.

In another aspect the invention the process anaerobically treats a feed of swine and/or dairy manure comprising a liquid containing suspended solids using anaerobic digestion in a reaction system having an input cell, an output cell, and at least two intermediate cells located below the adjacent ground level in a lagoon. Each cell retains a volume of liquid and suspended solids and partitions define separate adjacent cells with each cell adjacent to at least one other cell. Each partition defines a passageway for serial flow of liquid and suspended solids from the input cell through the intermediate cells and to the output cell. The feed enters a lower portion of the input cell and the flow of liquid and suspended solids entering cells enters a lower portion of each adjacent cell. The SRT of each cell exceeds its HRT. One or more membranes cover the cells to collect biogas from the cells. The feed periodically passes to the input cell to produce a periodic gravity induced flow of liquid comprising a supernatant and entrained solids from the input cell, serially through the intermediate cell(s), and to the output cell while minimizing mixing in the cells to increase the passing of supernatant and decrease the passing of solids to a downstream cell. At least the input cell operates as an AnSBR wherein the liquid and solids undergo at least some mixing between feed additions. The concentration of suspended solids entering the input cell ranges from 5,000 mg/L to 40,000 mg/L. At least one of the intermediate cells operates as an UAC. The settling zone settles solids into its lower portion to produce settled solids therein and a solids lean liquid in an upper portion of the output cell. An intermediate cell and/or the input cell (directly and/or via addition to the feed receive at least a portion of settled solids withdrawn from a lower portion of the output cell. The process then recovers treated solids from below the midpoint of the output cell and treated liquid from above the midpoint of the output cell.

In another aspect the invention treats a feed of SM or CSM comprising liquid containing suspended solids using a combination of the feed of CSM or SM and additional feed from a large lagoon (almost always an on-site lagoon) in the MCLR with each lagoon retaining suspended solids below the adjacent ground level. The large lagoon may be an anaerobic lagoon and is almost always an on-site lagoon. One or more enclosures cover the MCLR and the large lagoon to collect biogas from the lagoons. The MCLR retains a volume of liquid and solids that does not exceed 20% of the liquid and solids in the large lagoon. The MCLR contains an input cell, an output cell, and at least one intermediate cell in series. Partitions restrict the flow of liquid and suspended solids between cells and each cell operates with a solids retention SRT that exceeds its HRT. The feed at least periodically passes to the MCLR and the large lagoon and at least periodically passing solids from the large lagoon to the MCLR. At least the input cell operates as an AnSBR and at least one of the intermediate cells operates as a UAC. Separated solids withdrawn from the MCLR produce a solids lean liquid and a concentrated solids stream. At least at least a portion of the concentrated solids pass to the large lagoon, to an upper portion of the MCLR, and/or from the process. The process recovers treated solids by withdrawing a portion of the concentrated solids; a treated liquid from the solids lean liquid; and biogas produced in the MCLR and the large lagoon.

In another embodiment at least one cell operates as an UAC and any cell operating as a UAC is located downstream of at least one cell that operates as an AnSBR.

In another embodiment at least one cell operates as an AnSBR that mixes the solids and liquid contained therein by periodic hydraulic mixing.

In another embodiment the input cell operates as an AnSBR and at least one intermediate cell operates as an UAC.

In another embodiment the HRT varies between at least two cells.

In another embodiment each cell is adjacent to another cell, a partition separates adjacent cells, and a passageway passes liquid and solids from one cell to an adjacent cell.

In another embodiment the feed enters the input cell through a flow channel that discharges the entering feed into a lower portion of the input cell.

In another embodiment a baffle located in at least one intermediate cell and/or the output cell forms part of a flow channel in communication with a passageway that directs entering solids and liquid into a lower portion of the cell.

In another embodiment the output cell operates as a settling zone that settles and concentrates solids into a lower portion of the output cell and provides a solids lean liquid in an upper portion of the output cell.

In another embodiment supernatant from the last intermediate cell enters a lower portion of the output cell.

Another embodiment withdraws a settled solids recycle stream from a lower portion of the output cell and recycles it to an intermediate cell, the input cell, and/or the feed.

In another embodiment at least a portion of the treated liquid passes to a UF membrane to produce a concentrated solids stream and a cleaned water stream.

In another embodiment all UAC cells that undergo mixing receive hydraulic mixing.

Another embodiment injects a solids lean liquid withdrawn from an upper portion of the output cell into the lower portion of a cell operating as a UAC to produce an upflow in the UAC cell.

In another embodiment solids from a large lagoon pass to a MCLR at a rate that reduces the overall volume of solids in the large lagoon.

In another embodiment a greater amount of feed periodically passes to the large lagoon or the MCLR.

In another embodiment a UF membrane separates the suspended solids from the MCLR to produce a cleaned water stream as the solids lean liquid and to produce the concentrated solids stream;

Other aspects and advantages will become apparent upon consideration of the following detailed description and the attached drawings wherein like numerals designate like structures throughout the specification.

### BRIEF DESCRIPTION OF THE DRAWINGS

FIG. 1 is a schematic overhead view of an MCLR showing cells separated by partitions and piping components.

FIG. 2 is a schematic side view of the MCLR of FIG. 1 taken across section A-A showing an additional view of that depicted in FIG. 1.

FIG. 3 is a schematic profile view of a typical large anaerobic lagoon integrated with an MCLR and piping components for the function of the integrated arrangement.

The figures schematically show basic elements of the equipment used in practicing the process. The figures omit pumps, valves, instrumentation, control system etc. that are known by those designing and using the equipment for practicing the invention and readily incorporated by those generally familiar with equipment, design, and operation of similar equipment.

### DETAILED DESCRIPTION

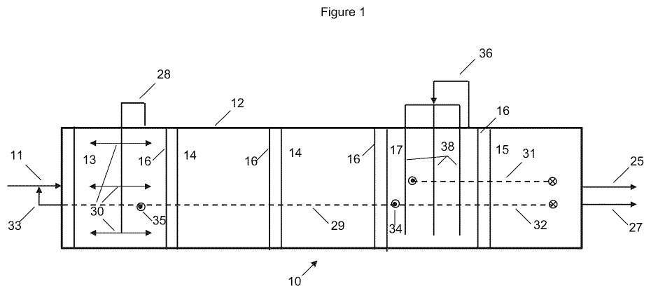

In more detail FIG. 1 shows a feed 11 entering a preferred MCLR arrangement 10 defined by containment walls 12 that holds a mixture of solids and liquids in a series of cells, (cell 13, 14, 17, 15) that are defined in part by containment walls 12 and partitions 16 that separate the lagoon of the MCLR 10 into the separate cells. MCLR 10 extends at least partially into the ground; the containment walls usually comprise the earthen walls of a pit and/or an earthen embankment but other structures and materials such as those mentioned may provide all or a portion of containment walls 12. The arrangement of partitions 16 that define the cells show a preferred arrangement wherein all the cells retain approximately equal liquid volumes, and each cell has at least one directly adjacent cell. However, in some cases varying the volume of the cells may better suit the operation of the MCLR.

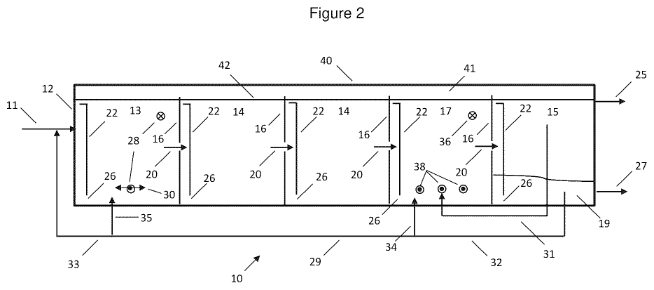

All the cells are hydraulically interconnected and liquid flows by gravity from one cell to the next. Preferably, as shown in FIG. 2, liquid flows through the partitions via openings 20 that are usually in the form of cut-outs. The openings in the partitions are preferably located from the top to the midpoint of the partition thereby extracting liquid that comprises water and facilitating the retention of suspended solids in the lower portion of the cells to increase the collection of suspended solids retention in the bottom of the cells. The cells in almost all cases include a baffle 22 located in each cell that directs the liquid entering via partition opening 20 to an opening 26 located at the bottom of each partition 16 to provide the preferential transfer of liquid from one cell to the bottom of an adjacent cell.

The cells will provide different types of operations in the process. At least one cell will operate as an AnSBR and at least one cell located downstream of the AnSBR cell will operate as an UAC cell. FIGS. 1 and 2 show an arrangement where first cell 13 and succeeding cells 14 are AnSBR cells, the next cell 17 is a UAC cell and final cell 15 an output cell. In this case output cell 15 clarifies the liquid therein by settling solids to the bottom portion of cell 15 and therefore is also referred to as a settling cell. One or more treated effluents will leave a settling cell. FIGS. 1 and 2 show liquid effluent 25 and a treated solids effluent 27 exiting settling cell 15. The MCLR will have at least 3 cells and typically between 3 to 7 cells and most typically 5 cells. Preferably the MCLR has 2 to 5 intermediate cells.

A preferred MCLR process arrangement uses several cells in series that all operate as AnSBR cells followed by a cell that operates as UAC type cell and a final clarification/settling type cell. FIGS. 1 and 2 can be adapted to schematically suit this operational mode of the process. More specifically a feed 12 of wastewater periodically enters the bottom of the cell 13 that operates as an AnSBR type cell. While feed 12 enters, no mixing is applied to cell 13 or any of the other cells downstream AnSBR cells 14. The flow of feed 11 into first cell 13 causes liquid to flow, without pumping, from the cell 13 through the remaining cells via the partition openings 20. In other words, periodically adding manure to the first cell, cell 13, propagates flow such liquid is “overflowed” to the second cell, first cell 14, and from the second cell to the third cell, second cell 14 and so on. The cut outs in the wall can be near the top to the midpoint of the cells water depth keeping them in liquid communication resulting in the liquid levels within all the cells reaching the same level, but preferentially retaining suspended solids in the lower portion of the cells resulting in increased suspended solids retention in the cells. Avoiding mixing preferentially settles solids in any cell operating as an AnSBRs and such cells operate as settling cells in which the SRT is much greater than the HRT. Maintaining denser solids, referred to as a “sludge blanket,” in the bottom half of the UAC cell gives it the considerably higher SRT relative to the HRT. The HRT of each cell is typically in a range of from 0.5 days to 2.0 days, although longer HRTs can be used. The HRT of each cell can vary, depending on the type of wastewater and the concentration of TSS/VSS.

After feed addition, the cells are mixed for a time that will thoroughly mix the contents of cell. Mixing subsequently stops and the solids in the cells settle for a time period in which reaction and settling of the solids occurs. The reaction refers to biological reactions that take place before the next addition of feed to the first cell. This cycle repeats at a frequency that allows good separation of the suspended solids in each cell and sufficient mixing to achieve good COD and solids conversion efficiency.

The cells can be mixed in a variety of different ways. A preferred method uses hydraulic mixing system that employs pumps to withdraw liquid from a cell and return liquid to a cell through the controlled velocity openings of nozzles or jet mixers. FIG. 1 schematically illustrates this hydraulic mixing in cell 13 where a mixing pipe 28 withdraws liquid from an upper portion of cell 13

and via pumping (not shown) injects the liquid into the bottom of that same cell via ejection nozzles 30. Other known forms of mixing may be used such as mechanical and/or gas mixing. Any cell operating as AnSBR may benefit from such mixing.

In the operation depicted by FIGS. 1 and 2 any liquid flow from the final AnSBR cell overflows into the UAC cell as in the same manner as the upstream AnSBR cells. However, the UAC cells have no settling period; instead, UAC cells operate with a liquid upflow velocity that will maintain a flocculent bed of suspended solids (TSS) in the bottom of the UAC. FIGS. 1 and 2 illustrate a few possible ways to maintain the flocculent bed. The arrangement can withdraw a solids lean liquid above the settled solids in settling cell 15 and via a line 31 inject the liquid to the bottom of cell 17. Injected liquid returns to cell 15 via partition opening 20. Alternatively, or in conjunction with the circulation via line 31, a line 36 may withdraw liquid from an upper portion of cell 17 and reinject it into a lower portion of cell 17 through one or more distribution pipes or pipe spargers 38. No matter what method flocculates a UAC bed any upflow velocity in such cells is usually increased temporarily during the pulsing of feed to the AnSBR cells that propagates liquid to the UAC cell.

The settling cell can simply employ gravity settling or enhance settling by incorporating other structures or conditions to improve settling. A preferred arrangement utilizes lamella-type plates (not shown) to provide additional surface area for retaining settled solids. As shown in FIG. 2, the overflow from the UAC cell can be directed to enter the bottom of the settling cell to enhance settling. In some arrangements a short HRT degassing cell can be inserted between the UAC and settling cell to improved suspended solids retention.

Settled sludge collects in the bottom of settling cell 15 as sludge bed 19. Sludge from cell 15 may be recycled, on a periodic or constant basis, back to any UAC cell or any AnSBR cell to further increase the SRT. FIG. 2 shows recycling of sludge from the last cell 15 to first cell 13 recycled to feed line 11 via lines 32, 29, and 33. Alternatively or in addition to recycling sludge to feed line 11 sludge may enter cell 13 directly via lines 32, 29, and 35. FIG. 2 also shows the recycling of sludge from the settling cell 15 to immediately preceding UAC cell 17 via lines 32 and 34. Excess sludge is normally withdrawn from settling cell 15 via a line 27 and wasted.

In another arrangement, the solids sludge from the MCLR is further treated using a UF membrane. Adding the UF membrane to MCLR arrangement enables production of a liquid effluent with essentially no suspended solids. The absence of suspended solids makes possible further treatment of liquid effluent to capture ammonia and/or remove dissolved metals such as copper, zinc, lead, and cadmium. Removing these dissolved metals allows land application of the liquid for crops and spraying fields at significantly reduced levels of metals build-up of metals.

FIG. 1 also shows a cover 40 typically comprising a membrane that forms an enclosure or chamber in the form of a plenum 41. Plenum 41 captures gases from the cells that rise above the liquid level 42. Collection of gas from plenum 41 may include a suction system to improve gas recovery. Gas collected from MCLR 10 comprises purifiable gas suitable for sale or use on site. Such uses include upgrade the gas to RNG, the generation of electricity, or as fuel to an engine for power and/or combined power and heat.

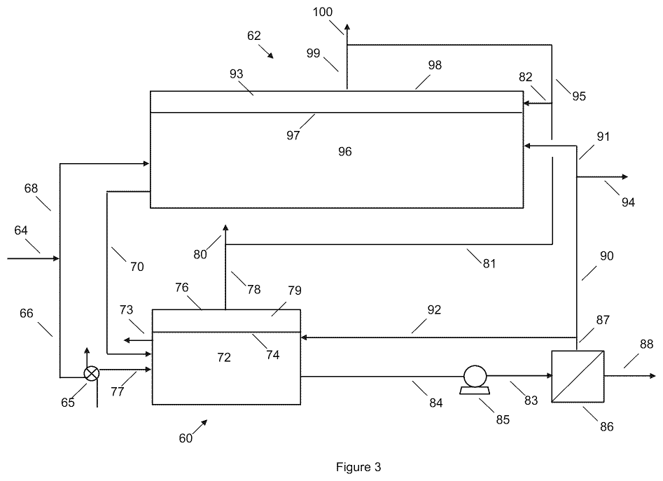

In another highly beneficial arrangement suited particularly to the treatment of SM, an MCLR works in combination with a large lagoon. FIG. 3 schematically illustrates this arrangement and some of the piping and equipment for using an MCLR 60 together with a large lagoon 62.

SM can flow to both the large lagoon and the MCLR, but the amount of SM, if any, flowing to the large lagoon and/or the MCLR will typically vary over different time periods. Particularly in SM operations where the generation of manure varies greatly over the life cycle of the animals little to no feed may flow to the large lagoon or the MCLR. SM, typically from a hog housing, enters the lagoon arrangement via line 64 and can pass SM to MCLR 60 via line 66 and/or lagoon 62 via line 68. Where provided a heat exchanger 65 will provide heat to the CSM/SM of line 66 before it enters bed 72 via line 77. A line 70 may transfer settled solids from lagoon 62 to MCLR 60 to work off accumulated solids retained in lagoon 62.

MCLR 60 operates in a similar manner to that previously described above. MCLR 60 contains a multiplicity of cells (not shown) that function in the various ways as previously described. Shown in simplified form, the cells in MCLR 60 collectively retain a bed 72 of liquid/solids up to a liquid level 74 in MCLR 60. A cover 76 defines a head space 79 above bed 72 that collects gases.

A line 78 recovers gases from above a liquid level 74 of MCLE 60. These gases may be directly recovered by a line 80 for the uses previously described or transferred to the head space 71 of lagoon 62 via lines 81 and 82 so the combined gases can be more easily managed together or combined directly via line 95 with gases leaving headspace 93 via line 99 into a combined gas stream 100.

Lagoon 62 operates conventional manner to receive, store, and treat SM. In lagoon 62 settled solids and liquid form a bed 96 having a higher concentration of solids in its lower portion and a lower concentration of solids in its upper portion.

A cover 98 defines the top of head space 93 that captures gases rising from a liquid surface 97 and any gases coming from MCLR 60 via line 82. Line 99 collects gas that may come from only lagoon 62 or can constitute combined gas from MCLR 60 and lagoon 62. The gas composition of the gas recovered by line 99 is similar to that recovered from the MCLR by line 78. The covered arrangements of MCLR 60 and the large lagoon 62 advantageously allows biogas from MCLR 60 to flow to lagoon 62 for storage and/or biogas flow equalization that enables the gas to flow to a final use as previously described via line 100.

With respect to effluents, line 84 withdraws a stream of primarily solids from the liquids and a pump 85 drives solids/liquids from line 82 via a line 83 to a separator 86 comprising a UF membrane. Pump 85 pressurizes the contents of line 83 for separation of solids from liquid in separator 86. Separator 86 recovers a stream of solids via line 87 and delivers a primarily liquid stream via a line 88.

Line 87 can direct the recovered solids all or in part to various destinations including MCLR 60 via line 92, lagoon 62 via a line 90 and 91 for storage therein, and/or for direct recovery via line 95. Settled solids recovered by line 95 may ultimately find use as a concentrated NPK product.

Cleaned water recovered from separator 86 by line 88 may be processed for nitrogen recovery and/or used for irrigation. In most cases when used for irrigation, the water from line 88 will undergo trace metal removal.

A line 73, if provided, withdraws a supernatant from an upper portion of the liquid/solids in bed 72. The supernatant can also provide another source of water that can undergo processing such as that described for the water withdrawn by line 88 and put to similar uses. It is also possible to use line 73 as the primary water withdrawal from bed 72 such that solids from line 84 are directly recovered. In this case the UF membrane may be eliminated and solids from the liquid/solids of bed 72 may be distributed lines 83, 84, 87, 90, 92, 95 and/or 84 in the manner previously described.

The MCLR may have many other arrangements and variations. The MCLR arrangement may vary the retentions volume of the cells. For example, in the arrangement depicted by FIGS. 1 and 2, the partitions may be spaced apart by varying distances to achieve this.

In addition, the MCLR need not comprise cells with rectangular or square cross sections. The lagoon of the MCLR refers to area over which cells are distributed. For example, in one arrangement the MCLR may comprise a series of cylindrical or obround depressions in the ground that are interconnected by appropriate piping to provide the gravity flow of the liquid and any recycling of solids or recirculation of liquid to provide mixing such as in an UAC cell. A variation of such an arrangement may use interconnected pits as the cells and the ground between the pits will provide the partitions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein.

Those skilled in the art will appreciate that numerous modifications to the present disclosure and that the illustrated embodiments are exemplary only and should not be taken as limiting the scope of the disclosure.

We claim:

1. A process for anaerobically treating a feed of swine manure and/or coarse screened dairy manure such that the feed contains liquid and suspended solids and the process uses a reaction system comprising a multicell lagoon reactor (MCLR) wherein the reaction system has an input cell, an output cell, and at least one intermediate cell with all cells in series and located at least partially below the adjacent ground level in a lagoon; each cell retains a volume of liquid and suspended solids; a partition restricts the flow of liquid and suspended solids between cells; each cell operates with a solids retention time that exceeds the hydraulic retention time (HRT); and one or more enclosures cover the cells to collect biogas from the cells, the process further comprising:
a. periodically passing the feed to the input cell to produce a periodic gravity induced flow of liquid comprising a supernatant and entrained solids from the input cell serially through any intermediate cells and from the final intermediate cell into the output cell while minimizing mixing in the cells to increase the passing of supernatant and decrease the passing of solids to a downstream cell;
b. operating the input cell and/or one or more intermediate cells as an anaerobic sequencing batch reactor (AnSBR);
c. periodically mixing the liquid and solids in the AnSBR for at least a portion of the time between the periodic additions of feed in step a.;
d. recovering treated solids from below the midpoint of the output cell; and,
e. recovering a treated liquid from above the midpoint of the output cell.

2. The process of claim 1 wherein each cell is adjacent to another cell, a partition separates adjacent cells and a passageway passes liquid and solids from one cell to an adjacent cell.

3. The process of claim 2 wherein the reaction system has 2 to 5 intermediate cells.

4. The process of claim 1 wherein at least one cell operates as an upflow anaerobic contact reactor (UAC) and wherein any cell that operates as a UAC is located downstream of at least one cell that operates as an AnSBR

5. The process of claim 1 wherein the HRT of each cell is in a range of from 0.5 days to 2.0 days.

6. The process of claim 1 wherein the HRT varies between at least two cells.

7. The process of claim 1 wherein the concentration of suspended solids entering the input cell ranges from 5,000 mg/L to 40,000 mg/L.

8. The process of claim 1 wherein the output cell operates as a settling zone that settles solids into a lower portion of the output cell to concentrate solids in the lower portion of the output cell and a solids lean liquid in an upper portion of the output cell.

9. The process of claim 2 wherein feed enters the input cell through a flow channel that discharges the entering feed into a lower portion of the input cell.

10. The process of claim 2 wherein a baffle is located in at least one intermediate cell and/or the output cell and the baffle forms part of a flow channel in communication with the passageway that directs entering solids and liquid into a lower portion of the cell.

11. The process of claim 1 wherein the periodic mixing within at least one cell is produced by hydraulic mixing, mechanical mixing, and/or gas mixing.

12. The process of claim 1 wherein at least one cell that operates as an AnSBR mixes the solids and liquid therein by periodic hydraulic mixing.

13. The process of claim 4 wherein the input cell operates as an AnSBR and at least one intermediate cell operates as a UAC

14. The process of claim 1 wherein a solids lean liquid is withdrawn from an upper portion of the output cell and injected into the lower portion of a cell that operates as a UAC to produce an upflow in the UAC cell.

15. The process of claim 1 wherein a settled solids recycle stream is withdrawn from a lower portion of the output cell and recycled to an intermediate cell, the input cell, and/or the feed.

16. The process of claim 1 wherein at least a portion of the treated liquid passes to a UF membrane to produce a concentrated solids stream and a cleaned water stream.

17. The process of claim 1 wherein supernatant from the last intermediate cell enters a lower portion of the output cell.

18. A process for anaerobically treating a feed of swine manure and/or coarse screened dairy manure such that the feed contains liquid and suspended solids and the process uses a reaction system comprising a multicell lagoon reactor (MCLR) wherein the reaction system has an input cell, an output cell, and at least two intermediate cells with all cells in series and located below the adjacent ground level in a lagoon; each cell retains a volume of liquid and suspended solids; each cells is adjacent to at least one other cell; a partition partially isolates each cell from an adjacent cell and defines a passageway for serial flow of liquid and suspended solids from the input cell through the intermediate cells and to the output cell; the feed enters a lower portion of the input cell and the flow of liquid and suspended solids entering all other cells enters a lower portion of that cell; the solids retention time in each cell exceeds the hydraulic retention time (HRT); and one or more membranes cover the cells to collect biogas from the cells, the process further comprising:
a. periodically passing the feed to the input cell to produce a periodic gravity induced flow of liquid comprising a supernatant and entrained solids from the input cell, serially through the intermediate cell(s), and to the output cell while minimizing mixing in the cells to increase the passing of supernatant and decrease the passing of solids to a downstream cell;
b. operating at least the input cell as an anaerobic sequencing batch reactor (AnSBR);
c. periodically mixing the liquid and solids in the AnSBR for at least a portion of the time between the feed additions of step a;
d. operating at least one of the intermediate cells as an upflow anaerobic contact reactor (UAC);
e. operating the output cell as a settling zone that settles solids into a lower portion of the output cell to produce settled solids in a lower portion of the output cell and a solids lean liquid in an upper portion of the output cell.
g. withdrawing settled solids from a lower portion of the output cell and recycling a portion of the settled solids to at least one of an intermediate cell, the input cell, and the feed;
g. recovering treated solids from below the midpoint of the output cell;
and,
h, recovering a treated liquid from above the midpoint of the output cell.

19. The process of claim 18 wherein the HRT of each cell is in a range of from 0.5 days to 2.0 days and the HRT varies between at least two cells.

20. The process of claim 18 wherein hydraulic mixing provides the mixing in any AnSBR cell.

21. The process of claim 18 wherein a solids lean liquid is withdrawn from an upper portion of the output cell and injected into a lower portion of a UAC cell to produce an upflow in the UAC cell.

22. The process of claim 18 wherein at least a portion of the treated solids pass to a UF membrane to produce a concentrated solids stream and a cleaned water stream.

23. A process for anaerobically treating a feed of swine manure and/or coarse screened dairy manure such that the feed contains liquid containing suspended solids and the process uses an arrangement of a large lagoon and a multicell lagoon reactor (MCLR) wherein the large lagoon and the MCLR retain suspended solids below the adjacent ground level and one or more enclosures cover the MCLR and the large lagoon to collect biogas from the large lagoon and the MCLR; wherein the MCLR comprises a volume of liquid and solids that does not exceed 20% of the volume of liquid and solids in the large lagoon; a reaction system in the MCLR having an input cell, an output cell, and at least one intermediate cell wherein all cells are in series; partitions that restrict the flow of liquid and suspended solids between cells; and operating each cell with a solids retention time that exceeds the hydraulic retention time (HRT), the process further comprising:
a. at least periodically passing the feed to the MCLR;
b. at least periodically passing the feed to the large lagoon;
c. at least periodically passing solids from the large lagoon to the MCLR;
d. operating at least the input cell as an anaerobic sequencing batch reactor (AnSBR).
e. operating at least one of the intermediate cells as an upflow anaerobic contact reactor (UAC);
f. withdrawing and separating suspended solids from the MCLR to produce a solids lean liquid and a concentrated solids stream;
g. passing at least a portion of the concentrated solids to the large lagoon, to an upper portion of the MCLR, and/or from the process;
h. withdrawing a portion of the concentrated solids stream from the process for recovery of treated solids;
i. recovering a treated liquid from the solids lean liquid; and,
j. recovering the biogas produced in the and the large lagoon.

24. The process of claim 23 wherein solids from the large lagoon pass to the MCLR at a rate that reduces the overall volume of solids in the large lagoon.

25. The process of claim 23 wherein a greater amount of feed periodically passes to one of the large lagoon or the MCLR.

26. The process of claim 23 wherein a UF membrane separates the suspended solids withdrawn from the MCLR to produce a cleaned water stream as the solids lean liquid and to produce the concentrated solids stream.

27. The process of claim 23 wherein the large lagoon provides anaerobic digestion.
